(19) United States
(12) Patent Application Publication
(10) Pub. No.: US 2011/0246706 A1
(43) Pub. Date: Oct. 6, 2011

(54) DISK ARRAY CONFIGURATION PROGRAM, COMPUTER, AND COMPUTER SYSTEM

(75) Inventors: Masayuki GOMYO, Hadano (JP); Shinji MARUOKA, Isehara (JP)

(73) Assignee: Hitachi, Ltd., Tokyo (JP)

(21) Appl. No.: 12/967,644

(22) Filed: Dec. 14, 2010

(30) Foreign Application Priority Data
Mar. 30, 2010 (JP) 2010-076529

(51) Int. Cl. G06F 12/02

(52) U.S. Cl. 711/103; 711/E12.008

(57) ABSTRACT

To improve the data input/output performance of a disk array with a hybrid configuration of flash memory and HDDs. A computer that executes a disk array configuration program in accordance with the present invention, when relocating a file from a hard disk to flash memory, stores the file in cache memory without immediately writing the file to the flash memory if the file size is smaller than the block size of the flash memory.

### CLAIM OF PRIORITY

The present application claims priority from Japanese patent application JP 2010-076529 filed on Mar. 30, 2010, the content of which is hereby incorporated by reference into this application.

### BACKGROUND OF THE INVENTION

1. Field of the Invention

The present invention relates to a technique for configuring a disk array.

2. Background Art

A flash memory device such as an SSD (Solid State Disk) that uses NAND flash memory as a storage medium (hereinafter, such flash memory device shall be referred to as an SSD) is a very fast drive with an input/output performance of about 30 times that of an HDD (Hard Disk Drive). With the advent of SSDs, it has become possible to implement a disk array with a faster speed than those of the conventional disk arrays (RAID: Redundant Arrays of Inexpensive (or Independent) Disks). However, the cost of an SSD per unit of storage capacity is as high as about five times that of an HDD, while the storage capacity of an SSD is as low as about ⅕ to 1/10 that of an HDD. Therefore, configuring a disk array (RAID) with the use of only SSDs would not be cost-effective or realistic.

Thus, it is considered that using a hybrid configuration of SSDs and HDDs may maximize the input/output performance of the SSDs and thus realize a cost-effective disk array.

For example, according to Reference 1 (United States Patent No. 2009/0265506), an SSD disk array and a HDD disk array are integrated using a virtual file system, whereby the two disk arrays are presented as a single disk array to a user application. According to Reference 1, the access frequency of a requested file in the integrated file system is calculated, and the cost and the advantage associated with the migration of data to the SSD are calculated based on the access frequency data, so that files are migrated dynamically between the two disk arrays. Through such processes, frequently accessed files are automatically migrated to the SSD, resulting in apparently increased access speed of the disk array.

### SUMMARY OF THE INVENTION

According to the technique disclosed in Reference 1, each time data input/output is generated, files are migrated between the SSD and the HDD as needed in parallel with the ordinary input/output. By such dynamic file relocation, extra data input/output is generated, which significantly influences the input/output performance.

In typical SSDs, a plurality of pages constitutes a single block. Write/read processes are performed in units of a page, while an erase process is performed in units of a block. Therefore, in order to rewrite a single page of a given block A, the following operations should be performed: copying an area, immediately before the portion to be rewritten, of the block A to another block B; writing a page to be written over to a corresponding portion of the block B; copying an area, immediately after the portion to be rewritten to the end block, of the block A to the block B; and erasing the block A. As described above, when files are relocated on the SSD, a number of data write operations and erase operations are generated. Thus, program-erase cycles (P/E cycles) of the SSD would be consumed faster than in normal use. An SSD has about 100000 program-erase cycles of memory cells, which is a much smaller number than that of HDDs. Since the conventional methods do not take such drawbacks into consideration, it is possible that the lifetime of the SSD can be shorter, which eventually will decrease the cost-effectiveness.

The present invention has been made in order to solve the aforementioned problems. It is an object of the present invention to improve the data input/output performance of a disk array with a hybrid configuration of flash memory and HDDs.

A computer that executes a disk array configuration program in accordance with the present invention, when relocating a file from a hard disk to flash memory, stores the file in cache memory without immediately writing it to the flash memory if the file size is smaller than the block size of the flash memory.

The disk array configuration program in accordance with the present invention, when relocating a file to the flash memory, caches a small-size file without immediately writing it to the flash memory. Thus, the number of write operations to the flash memory can be reduced. Accordingly, performance related to the file relocation can be improved, and the program-erase cycle endurance of the flash memory can be enhanced.

### BRIEF DESCRIPTION OF THE DRAWINGS

In the accompanying drawings:

FIG. 1 is a functional block diagram of a computer 100 that executes a disk array configuration program in accordance with Embodiment 1;

FIG. 2 is a diagram showing the structure of a file relocation list 114 and data examples;

FIG. 3 is a diagram showing the structure of a file access frequency table 115 and data examples;

FIG. 4 is a diagram showing the structure of an SSD block size definition table 116 and data examples;

FIG. 5 shows an operation flow in which a filter driver 117 narrows the access to a storage device 330 down to the access to a logical drive (P) 310;

FIG. 6 shows a detailed flow of S503 in FIG. 5;

FIG. 7 shows a detailed flow of step S504 in FIG. 5;

FIG. 8 is a diagram showing the operation flow of a file-relocation instruction OS service 112;

FIG. 9 shows an operation flow for acquiring the block size of each SSD; and

FIG. 10 shows an operation flow of a file-relocation execution module 117c.

### DESCRIPTION OF SYMBOLS

100 computer
110 main memory unit
111 system configuration interface
112 file-relocation instruction OS service
113 system configuration information
114 file relocation list
1141 No. column
1142 file ID column
1143 device ID column
1144 cache operation column
115 file access frequency table
1151 No. column
1152 file ID column
1153 device ID column
1154 access count column
1155 file size column
1156 last access time column
116 SSD block size definition table
1161 device ID column
1162 vendor name column
1163 product name column
1164 block size column
117 filter driver
117a file access sorting module
117b file access monitoring module
117c file relocation execution module
118 RAID device driver
120 CPU
200 RAID controller card
210 RAID firmware
300 storage device
310 logical drive (P)
320 logical drive (Q)
330 file list
340 write-back cache

### DETAILED DESCRIPTION OF THE PREFERRED EMBODIMENTS

### Embodiment 1

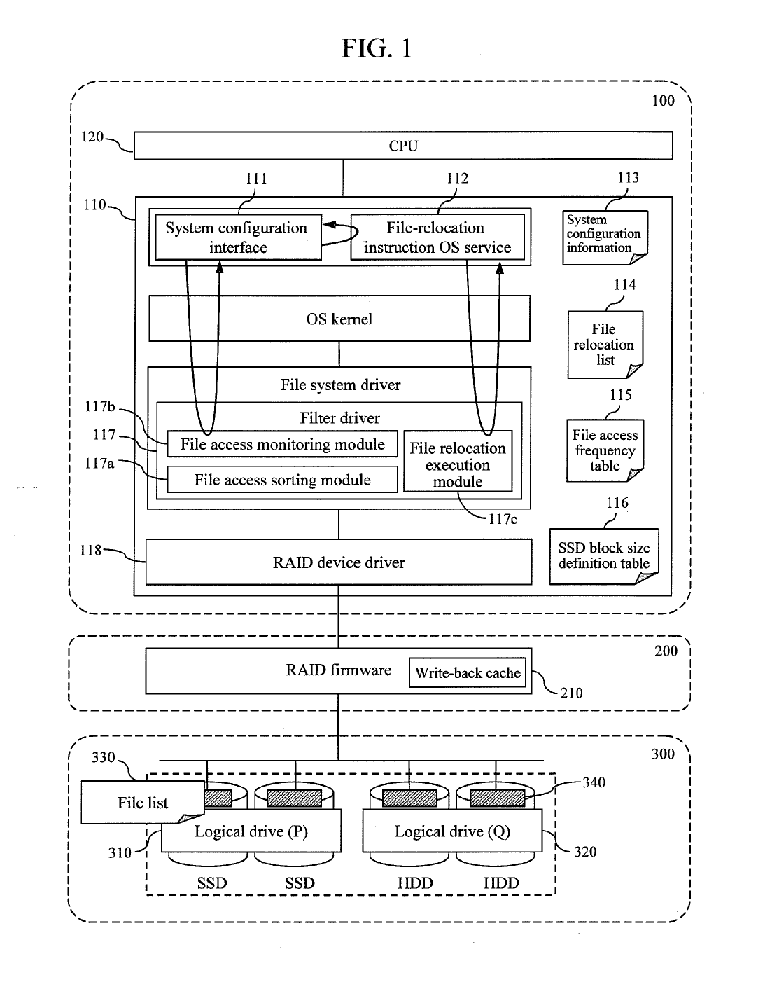

FIG. 1 is a functional block diagram of a computer 100 that executes a disk array configuration program in accordance with Embodiment 1 of the present invention. The computer 100 includes a main memory unit 110 and a CPU 120. The computer 100 is connected to a RAID controller card 200. The RAID controller card 200 is connected to a storage device 300.

In the storage device 300, a disk array is configured with the function of a RAID device driver 118. The computer 100 delegates some processes with a high operation load such as a parity operation to the RAID controller card 200.

The main memory unit 110 stores therein a system configuration interface 111, a file-relocation instruction OS (Operating System) service 112, system configuration information 113, a file relocation list 114, a file access frequency table 115, an SSD block size definition table 116, a filter driver 117, and a RAID device driver 118. In addition, software such as an OS kernel or a file system driver is read into the main memory unit 110 as needed.

The system configuration interface 111 is a program for a user of the computer 100 to set a parameter related to the operation of the disk array. The thus set parameter is stored in the system configuration information 113. For example, it is possible to set a parameter that indicates whether or not an SSD and an HDD should hold identical files in an overlapped manner.

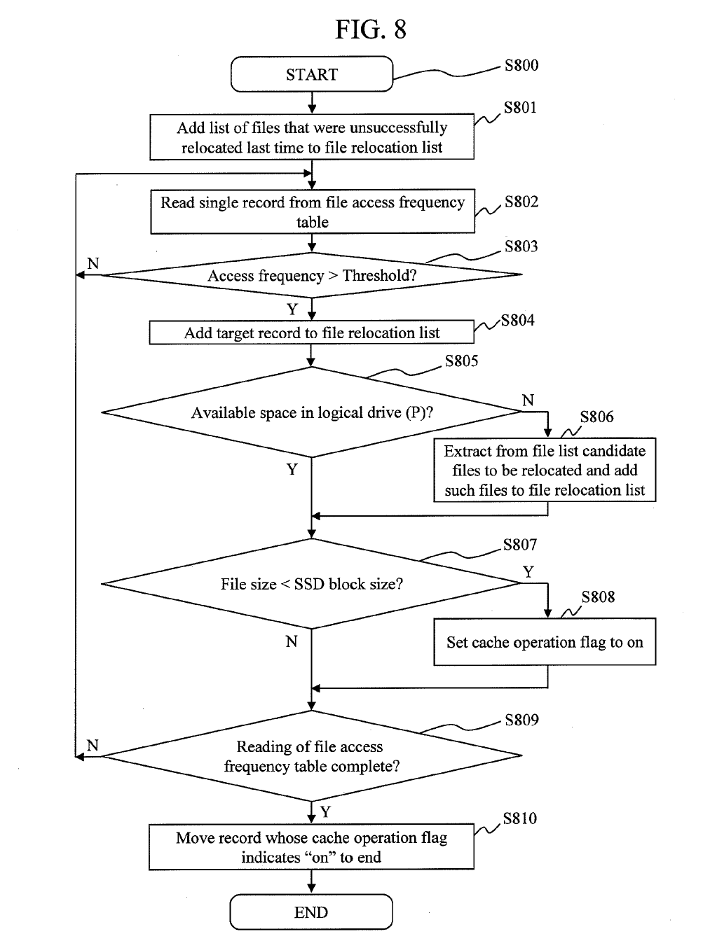

The file-relocation instruction OS service 112 executes an operation flow described with reference to FIG. 8 below, and creates the file relocation list 114 for issuing an instruction to relocate files between an SSD and an HDD in the storage device 300.

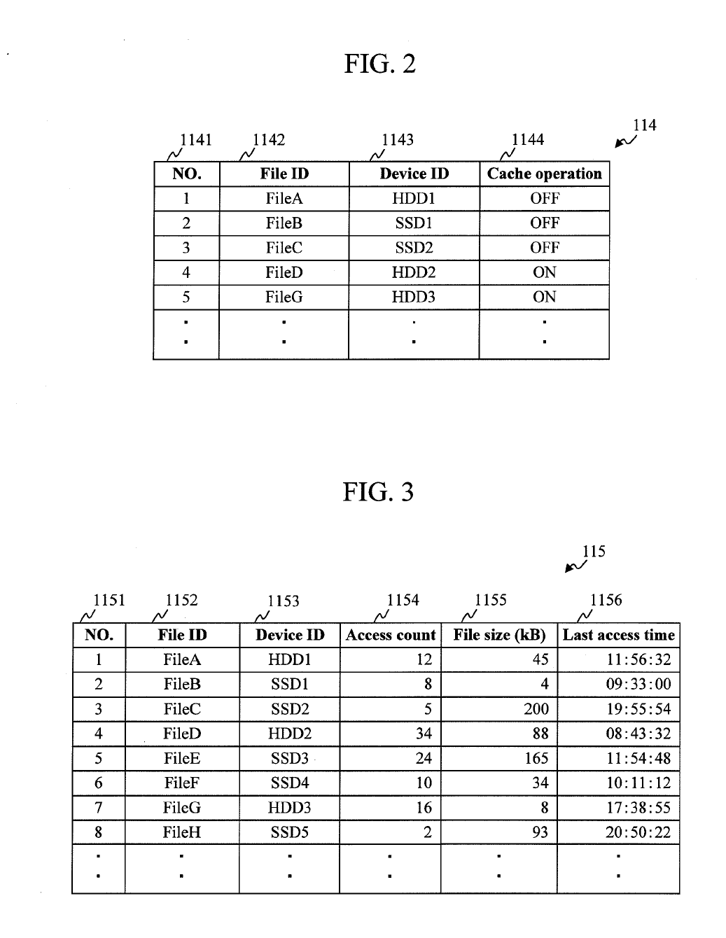

The details of the file relocation list 114, the file access frequency table 115, and the SSD block size definition table 116 will be described with reference to FIGS. 2 to 4 below.

The filter driver 117 is a program that operates between the entry point of the file system and the actual process of the file system and is able to trap access to the storage device 300. The filter driver 117 includes a file access sorting module 117a, a file access monitoring module 117b, and a file relocation execution module 117c. The details of such modules are described below. Two or more of such modules can be combined as needed, or all of such modules can be implemented as individual program modules. Alternatively, such modules can be implemented as the functions of the main unit of the filter driver 117.

The filter driver 117 detects file access to a logical drive (P) 310 and file access to a logical drive (Q) 320, and narrows such two types of access down to the access to the logical drive (P) 310. File access can be detected by trapping a system call requesting that a file system operation be performed. When the OS is Windows (registered trademark), it is possible to obtain a control before an access request is delivered to the actual process of the file system from the entry point of the file system by using the filter driver 117. If the OS is Linux, a similar process can be performed by inserting a layer immediately below a VFS (Virtual File System).

The RAID controller card 200 includes RAID firmware 210. The computer 100 uses the function provided by the RAID firmware 210 via the RAID device driver 118.

The RAID firmware 210 manages the logical drive (P) 310 configured with SSDs and the logical drive (Q) 320 configured with HDDs. The logical drive (Q) 320 is hidden from layers above the filter driver 117, and only the logical drive (P) 310 is presented to such layers. The details will be described with reference to FIG. 5 below.

The logical drive (P) 310 stores therein a file list 330 that contains information on a list of IDs of all files residing in the logical drive (P) 310.

The “disk array configuration program” in accordance with the present invention corresponds to the system configuration interface 111, the file-relocation instruction OS service 112, the filter driver 117, and the RAID device driver 118. Two or more of such programs can be combined as needed, or all of such programs can be implemented as individual program modules. In addition, the function corresponding to the RAID firmware 210 can be held not in the RAID controller card 200 but in the computer 100.

In the following description, each program may sometimes be described as a subject that performs an operation for the sake of convenience of the description. However, in practice, each program is executed by the CPU 120.

The RAID card 200 has a write-back cache for temporarily holding data to be written to the storage device 300. In addition, each of the SSDs and HDDs in the storage device 300 also has a write-back cache 340 that serves the same purpose.

FIG. 2 is a diagram showing the structure of the file relocation list 114 and data examples. The file relocation list 114 is a table that holds a list of files to be relocated between the SSDs and HDDs, and contains a No. column 1141, a file ID column 42, a device ID column 1143, and a cache operation column 1144.

The No. column 1141 holds a number for identifying a record that is held in the file relocation list 114. The file ID column 1142 holds an identifier for identifying a file to be relocated in the storage device 300. The device ID column 1143 holds an identifier of a disk device in which a file, which is identified by the value of the file ID column 1142, is stored. The cache operation column 1144 holds a flag that indicates whether or not to store the file, which is identified by the value of the file ID column 1142, in cache memory.

FIG. 3 is a diagram showing the structure of the file access frequency table 115 and data examples. The file access frequency table 115 is a table that records the access frequency of files stored in the storage device 300, and contains a No. column 1151, a file ID column 1152, a device ID column 1153, an access count column 1154, a file size column 1155, and a last access time column 1156.

The No. column 1151 holds a number for identifying a record that is held in the file access frequency table 115. The file ID column 1152 holds an identifier for identifying a file whose access frequency is to be recorded, in the storage device 300. The device ID column 1153 holds an identifier of a disk device in which a file identified by the value of the file ID column 1152 is stored. The access count column 1154 holds an access count of the file identified by the value of the file ID column 1152. The file size column 1155 holds the file size (e.g., in units of bytes) of the file identified by the value of the file ID column 1152. The last access time column 1156 holds the last time the file identified by the value of the file ID column 1152 was accessed.

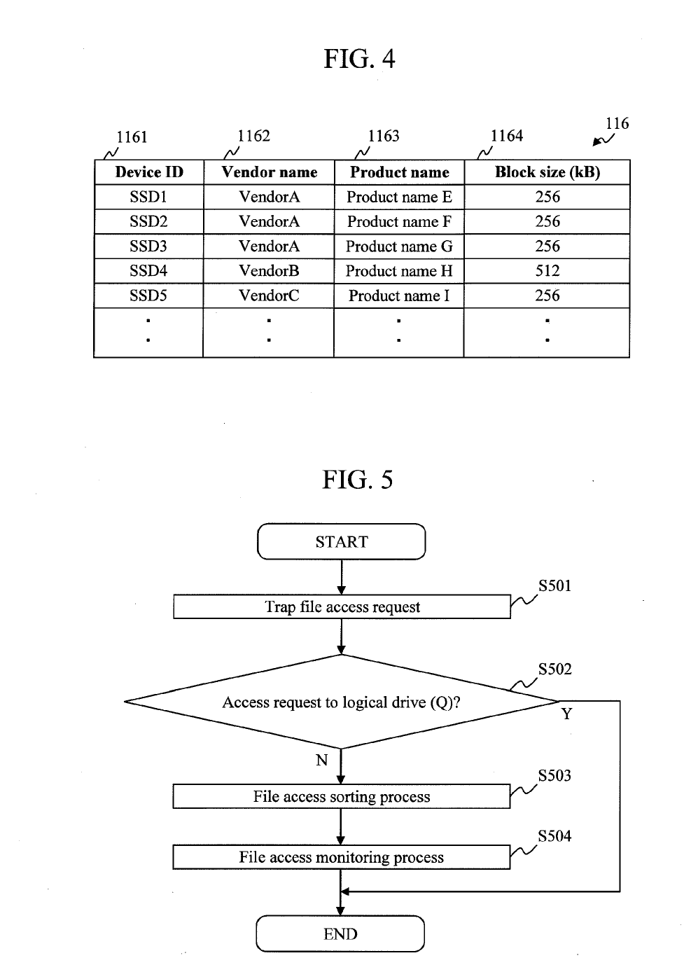

FIG. 4 is a diagram showing the structure of the SSD block size definition table 116 and data examples. The SSD block size definition table 116 is a table that describes the block size of each SSD in the storage device 300, and contains a device ID column 1161, a vendor name column 1162, a product name column 1163, and a block size column 1164.

The device ID column 1161 holds an identifier of each SSD in the storage device 300. The vendor name column 1162 and the product name column 1163 respectively hold the product vendor name and the product name of an SSD identified by the value of the device ID column 1161. The block size column 1164 holds the block size (e.g., in units of bytes) of the SSD identified by the value of the device ID column 1161.

The configuration shown in FIG. 1 has been described above. Next, the operation of each program shown in FIG. 1 will be described.

FIG. 5 shows an operation flow in which the filter driver 117 consolidates the access to the storage device 300 into the access to the logical drive (P) 310. The present operation flow aims to present only the logical drive (P) 310 to the OS and to allow the logical drive (P) 310 and the logical drive (Q) 320 to behave as if they are a single virtual logical drive. Each step in FIG. 5 will be described hereinafter.

### (FIG. 5: Step S501)

The filter driver 117 traps an access request to a file in the storage device 300.

### (FIG. 5: Step S502)

The filter driver 117 determines if the access request trapped in step S501 is directed to the logical drive (Q) 320. If the answer to step S502 is Yes, the filter driver 117 does not perform any process and terminates the present operation flow. If the answer to step S502 is No, the flow proceeds to step S503.

### (FIG. 5: Step S502: Supplement)

The present step has significance in consolidating the access initially issued to the storage device 300 into the access to the logical drive (P) 310. Access to the logical drive (Q) 320 is executed in the next step S503.

### (FIG. 5: Step S503)

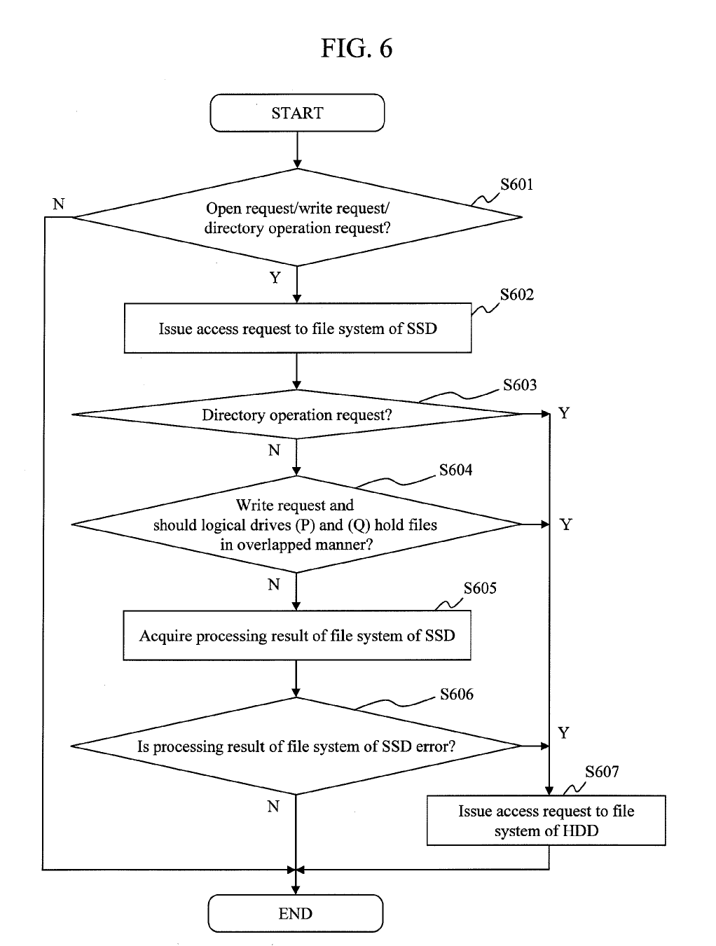

The filter driver 117 executes the function of the file access sorting module 117a described with reference to FIG. 6 below.

### (FIG. 5: Step S504)

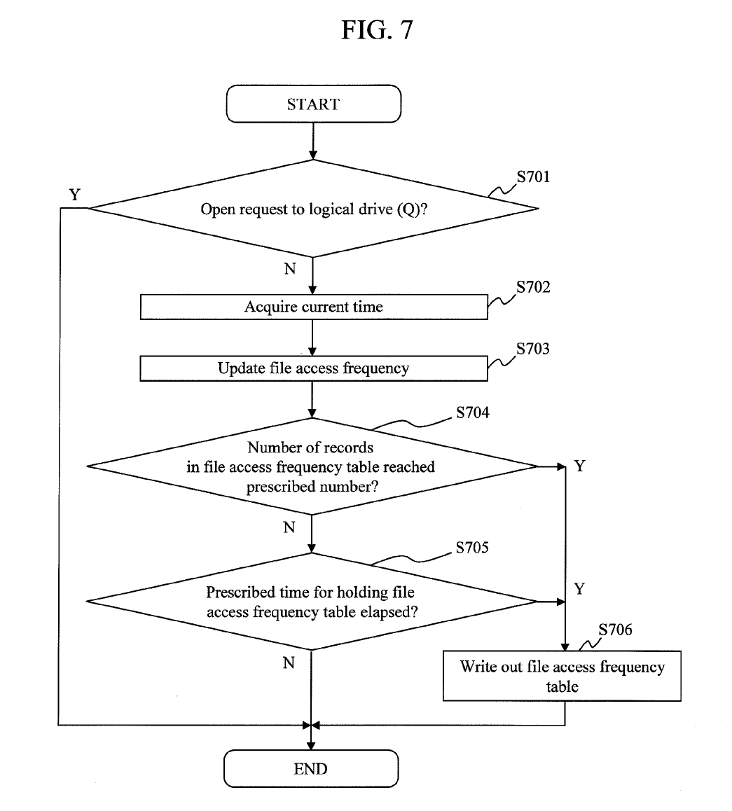

The filter driver 117 executes the function of the file access monitoring module 117b described with reference to FIG. 7 below.

FIG. 6 shows a detailed flow of step S503 in FIG. 5. Step S503 is a step of sorting an access request to the logical drive (P) 310 into the access to the logical drive (P) 310 or the logical drive (Q) 320. Hereinafter, each step in FIG. 6 will be described.

### (FIG. 6: Step S601)

The file access sorting module 117a determines which of an open request, a write request, and a directory operation request the access request trapped by the filter driver 117 in step S501 is. When the access request is any of such requests, the flow proceeds to step S602, and if not, the present operation flow ends.

### (FIG. 6: Step S602)

The file access sorting module 117a issues the access request, which has been trapped by the filter driver 117 in step S501, to the logical drive (P) 310, namely, the logical drive configured with SSDs.

### (FIG. 6: Step S603)

The file access sorting module 117a determines if the access request trapped by the filter driver 117 in step S501 is a directory operation request. If the answer to step S603 is Yes, the flow proceeds to step S607, and if the answer to step S603 is No, the flow proceeds to step S604.

### (FIG. 6: Step S603: Supplement)

In a disk array, each disk device should have the same directory structure in order to maintain the same file system configuration. Thus, the present step is provided in order that, when a directory operation is performed to the logical dive (P) 310, the same directory operation may be performed to the logical drive (Q) 320. Even if the logical drive (P) 310 and the logical drive (Q) 320 are not configured to hold identical files in an overlapped manner, it is possible that a file may be relocated to the logical drive (Q) 320 at some moment. Therefore, each drive is configured to have the same directory structure regardless of whether or not to hold identical files in an overlapped manner.

### (FIG. 6: Step S604)

The file access sorting module 117a determines if the access request trapped by the filter driver 117 in step S501 is a data write request and if the system configuration information 113 indicates that the logical drive (P) 310 and the logical drive (Q) 320 should hold identical files in an overlapped manner. If such conditions are satisfied, the flow proceeds to step S607, and if not, the flow proceeds to step S605.

### (FIG. 6: Step S605)

The file access sorting module 117a acquires a processing result of the access request issued to the file system of the logical drive (P) 310 in step S602.

### (FIG. 6: Step S606)

The file access sorting module 117a determines if the processing result of the access request issued to the file system of the logical drive (P) 310 in step S602 is an error. If the answer to step S606 is Yes, the flow proceeds to step S607, and if the answer to step S606 is Not, the present operation flow ends.

### (FIG. 6: Step S606: Supplement)

For example, if writing of data to the logical drive (P) 310 is attempted even if there is no available space in the logical drive (P) 310, or if an open request is issued to a non-existing file in the logical drive (P) 310, the present step reports an error. As a result of the present step, an access request to the logical drive (P) 310 is preferentially processed. Then, if the process cannot be continued for the aforementioned reasons and the like, the access is redirected to the logical drive (Q) 320.

### (FIG. 6: Step S607)

The file access sorting module 117a issues the access request, which has been trapped by the filter driver 117 in step S501, to the logical drive (Q) 320, namely, the logical drive configured with HDDs.

### (FIG. 6: Step S607: Supplement)

Patterns in which an access request is issued to an HDD in the present step include the three following patterns: (a) when a directory operation request is issued, (b) files are to be held in an overlapped manner, and (C) an access request issued to an SSD has failed.

FIG. 7 is a detailed flow of step S504 in FIG. 5. Step 504 is a step of monitoring access to the storage device 300, acquiring the access frequency statistics, and recording them on the file access frequency table 115. Hereinafter, each step in FIG. 7 will be described.

### (FIG. 7: Step S701)

The file access monitoring module 117b determines if the access request, which has been trapped by the filter driver 117 in step S501, is an open request to a file in the logical drive (Q) 320. If such conditions are satisfied, the present operation flow ends, and if not, the flow proceeds to step S702.

### (FIG. 7: Step S701: Supplement)

In this step, an access request to the logical drive (Q) 320 is excluded, and only an access request to the logical drive (P) 310 is handled. It should be noted, however, that access issued to the logical drive (P) 310 may eventually be redirected to the logical drive (Q) 320 depending on the operation flow described with reference to FIGS. 5-6.

### (FIG. 7: Steps S702 to S703)

The file access monitoring module 117b acquires the current time (S702), and records on the file access frequency table 115 the current time and the access request trapped by the filter driver 117 in step S501 (S703). The process of step S703 is performed on memory, and the file access frequency table 115 is held in the memory.

### (FIG. 7: Step S704)

The file access monitoring module 117b determines if the number of records recorded on the file access frequency table 115 has reached the prescribed upper limit number. If the answer to step S704 is Yes, the flow proceeds to step S706, and if the answer to step S704 is No, the flow proceeds to step S705.

### (FIG. 7: Step S705)

The file access monitoring module 117b determines if the prescribed time for continuously holding the file access frequency table 115 in the memory has elapsed or not. If the answer to step S705 is Yes, the flow proceeds to step S706, and if the answer to step S705 is No, the present operation flow ends.

### (FIG. 7: Step S706)

The file access monitoring module 117b writes out the file access frequency table 115 in the memory to a prescribed area in the storage device 300.

FIG. 8 is a diagram showing the operation flow of the file-relocation instruction OS service 112. The file-relocation instruction OS service 112 acquires the access frequency of each file described in the file access frequency table 115, and creates the file relocation list 114 that indicates information to the effect that frequently accessed files should be migrated to the logical drive (P) 310. Hereinafter, each step in FIG. 8 will be described.

### (FIG. 8: Step S800)

The CPU 120 boots the file-relocation instruction OS service 112 at a timing set by a user using the system configuration interface 111. The present operation flow starts upon boot of the file-relocation instruction OS service 112.

### (FIG. 8: Step S801)

The file-relocation instruction OS service 112 adds to the file relocation list 114 a list of files that were unsuccessfully relocated when the present operation flow was executed the last time.

### (FIG. 8: Step S802)

The file-relocation instruction OS service 112 reads a single record from the file access frequency table 115.

### (FIG. 8: Step S803)

The file-relocation instruction OS service 112 acquires the value of the access count column 1154 of the record read in step S802. If the value is greater than a predetermined threshold, the flow proceeds to step S804, and if not, the flow returns to step S802 to repeat the same process.

### (FIG. 8: Step S804)

The file-relocation instruction OS service 112 adds to the file relocation list 114 information on the record read in step S802 as a target file to be migrated to the logical drive (P) 310.

### (FIG. 8: Step S805)

The file-relocation instruction OS service 112 determines if the logical drive (P) 310 has sufficient available space needed for a file to be relocated thereto. If the answer to step S805 is Yes, the flow proceeds to step S807, and if the answer to step S805 is No, the flow proceeds to step S806.

### (FIG. 8: Step S806)

The file-relocation instruction OS service 112 extracts from the file list 330 files that should be relocated from the logical drive (P) 310 to the logical drive (Q) 320, and adds such files to the file relocation list 114. As a criterion for selecting files to be extracted from the file list 330 in the present step, the following methods are considered, for example: preferentially extracting a file with a large size, or preferentially extracting a less frequently accessed file.

### (FIG. 8: Step S806: Supplement)

The present operation flow aims to increase the access speed by preferentially using the logical drive (P) 310 in principle. However, as the logical drive (P) 310 should have an available space to that end, the present step secures such available space.

### (FIG. 8: Step S807)

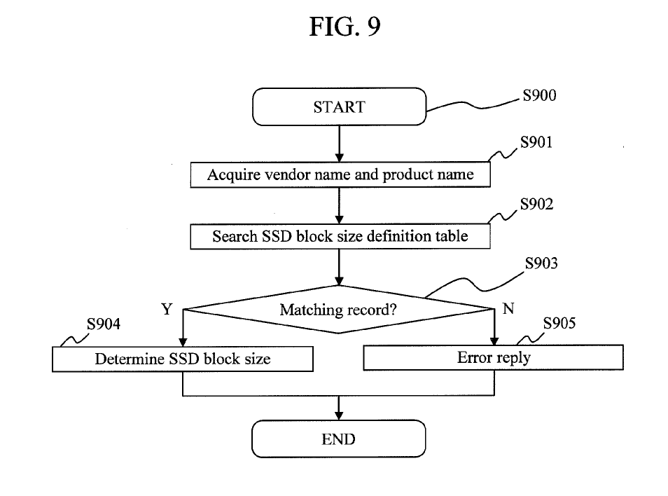

The file-relocation instruction OS service 112 compares the file size of a file that is described in the record read in step S802 with the block size of the SSD. If the file size is determined to be smaller, the flow proceeds to step S808, and if not, the flow proceeds to step S809. The block size of the SSD is acquired in advance by executing an operation flow described with reference to FIG. 9 below.

### (FIG. 8: Step S808)

The file-relocation instruction OS service 112 sets the cache operation column 1144 of a file, which corresponds to the record read in step S802, in the file relocation list 114 to “ON.”

### (FIG. 8: Step S809)

The file-relocation instruction OS service 112 determines if records up to the last record in the file access frequency table 115 have been read. If the answer to step S809 is Yes, the flow proceeds to step S810, and if the answer to step S809 is No, the flow returns to step S802 to repeat the same process.

### (FIG. 8: Step S810)

The file-relocation instruction OS service 112 moves a record whose cache operation column 1144 in the file relocation list 114 indicates “ON” toward the end of the file relocation list 114.

FIG. 9 shows an operation flow for acquiring the block size of each SSD. Hereinafter, each step in FIG. 9 will be described. It should be noted that the procedure for acquiring the block size described with reference to FIG. 9 is merely illustrative, and thus, other methods can also be used.

### (FIG. 9: Step S900)

The CPU 120 boots the file relocation execution module 117c when constructing a disk array. The present operation flow starts upon boot of the file relocation execution module 117c.

### (FIG. 9: Step S901)

The file relocation execution module 117c acquires the vendor name and the product name of each SSD in the storage device 300 by issuing a predetermined command to the SSD, for example. For example, an INQUIRY command used in controlling a SCSI device can be used.

### (FIG. 9: Step S902)

The file relocation execution module 117c searches the SSD block size definition table 116 using the vendor name and the product name acquired in step S901 as keys.

### (FIG. 9: Step S903)

When a record that matches the search keys is found in step S902, the flow proceeds to step S904, and if not, the flow proceeds to step S905.

### (FIG. 9: Step S904)

The file relocation execution module 117c identifies the block size of the SSD from the value of the block size column 1164 of the record found in step S902.

### (FIG. 9: Step S905)

The file relocation execution module 117c reports an error. Further, the procedure for configuring a disk array can be terminated as an error termination.

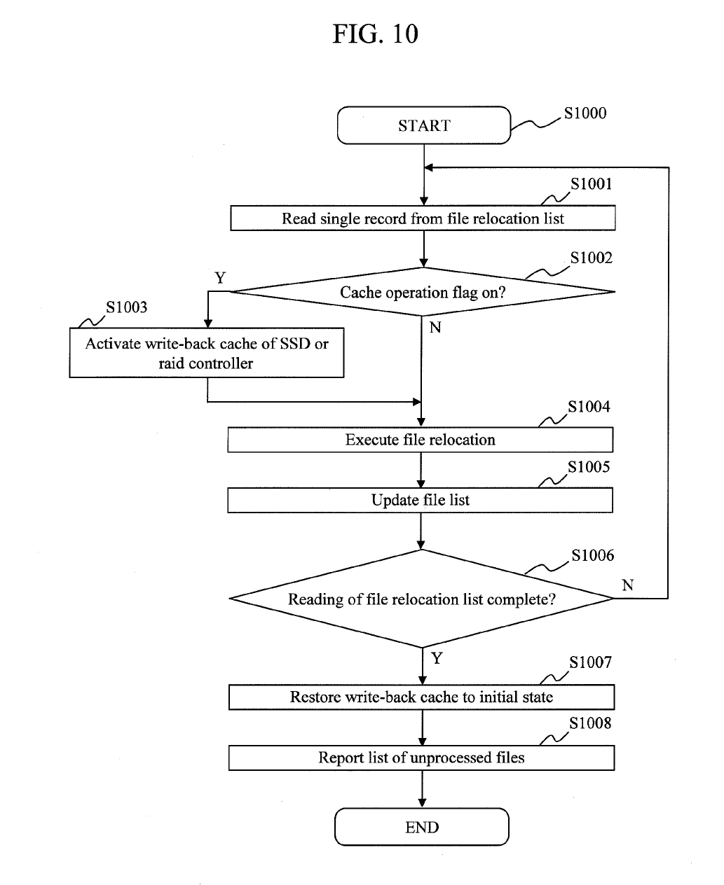

FIG. 10 shows an operation flow performed when the file-relocation execution module 117c performs file relocation. Hereinafter, each step in FIG. 10 will be described.

### (FIG. 10: Step S1000)

The file-relocation instruction OS service 112 boots the file-relocation execution module 117c. The present operation flow starts upon boot of the file-relocation execution module 117c.

### (FIG. 10: Step S1001)

The file-relocation execution module 117c reads a single record from the file relocation list 114.

### (FIG. 10: Step S1002)

The file-relocation execution module 117c proceeds to step S1003 if the cache operation column 1144 of the record read in step S1001 indicates “ON,” and proceeds to step S1004 if the cache operation column 1144 indicates “OFF.”

### (FIG. 10: Step S1003)

The file-relocation execution module 117c activates the write-back cache of the SSD or the RAID controller card 200.

### (FIG. 10: Step S1004)

The file-relocation execution module 117c relocates a file corresponding to the record read in step S1001. At this time, a file whose cache operation column 1144 indicates “ON” is written to not a disk device but to the write-back cache. Accordingly, files that are to be relocated from the logical drive (Q) 320 to the logical drive (P) 310 and whose file size is smaller than the block size of the SSD are, once written to the write-back cache, then collectively written to the SSD. Accordingly, the number of write operations to the SSD can be reduced. Files that are not written to the write-back cache are immediately written to the SSD.

### (FIG. 10: Step S1005)

The file-relocation execution module 117c updates the file list 330 based on the result of step S1004.

### (FIG. 10: Step S1006)

The file-relocation execution module 117c determines if records up to the last record in the file relocation list 114 have been read. If the answer to step S1006 is Yes, the flow proceeds to step S1007, and if the answer to step S1006 is No, the flow returns to step S1001 to repeat the same process.

### (FIG. 10: Step S1007)

The file-relocation execution module 117c restores the write-back cache activated in step S1003 to the initial state.

### (FIG. 10: Step S1008)

The file-relocation execution module 117c, if an error has occurred during the relocation process for the reason that the logical drive (P) 310 has run short of available space, for example, reports a list of files, which could not have been successfully relocated, to the file-relocation instruction OS service 112. Then, the file-relocation instruction OS service 112 adds the list of such files to the file relocation list 114 in step S801.

The operation of each program shown in FIG. 1 has been described above. As described above, according to Embodiment 1, the file-relocation execution module 117c, when relocating a file from a HDD to an SSD, does not immediately relocate a file whose file size is smaller than the block size of the SSD, but once stores such a file in the write-back cache. Accordingly, the number of write operations to the SSD can be reduced, and the program-erase cycle endurance can be enhanced. Further, using the write-back cache allows an increase in the data input/output performance of the storage device 300.

According to Embodiment 1, the filter driver 117 consolidates the access to files in the storage device 300 into the access to the logical drive (P) 310. The file access sorting module 117a sorts the access to files in the storage device 300 into the access to the logical drive (P) 310 or the logical drive (Q) 320. Accordingly, the logical drive (P) 310 and the logical drive (Q) 320 can be operated as a common virtual drive, and thus the internal processing can be hidden from a user, and user-friendliness can be increased.

In addition, according to Embodiment 1, the file access sorting module 117a causes the SSD and the HDD to hold identical files in an overlapped manner based on the configuration of the system configuration interface 111. Accordingly, the storage device 300 can be configured to perform a mirroring operation, so that even when one of the disk devices has crashed, the possibility of file loss can be reduced.

Further, according to Embodiment 1, the file access sorting module 117a creates the same directory structure for the SSD and the HDD. Accordingly, the SSD and the HDD can maintain the same file system configuration. Thus, files can be relocated from one logical drive to another without causing discrepancies on the file system.

Furthermore, according to Embodiment 1, the file-relocation instruction OS service 112 creates a record, which indicates that a file whose access frequency is greater than or equal to a predetermined threshold should be relocated from an HDD to an SSD, in the file relocation list 114. Accordingly, frequently accessed files are preferentially relocated to the fast-speed SSD, so that the data input/output performance of the storage device 300 can be increased.

### Embodiment 2

Embodiment 2 of the present invention will describe a specific example of the system configuration interface 111. The configuration of each device is the same as that in Embodiment 1.

Embodiment 1 described that the system configuration interface 111 determines whether or not the logical drive (P) 310 and the logical drive (Q) 320 should hold identical files in an overlapped manner. Hereinafter, the influence of the overlapped holding of identical files on the entire data input/output performance of the storage device 300 will be examined.

In Embodiment 1, when the logical drive (P) 310 and the logical drive (Q) 320 are configured to hold files in an overlapped manner, the file access sorting module 117a should perform writing to both the logical drives. In such a case, the apparent write speed of the entire storage device 300 will be lower than that when writing is performed only to the logical drive (Q) 320. Meanwhile, if each of the logical drive (P) 310 and the logical drive (Q) 320 holds files exclusively, the write speed depends on the write speed of each logical drive. Therefore, if the access is concentrated on the logical drive (P) 310, the apparent write speed of the entire storage device 300 will increase. The read speed depends on the read speed of each logical drive. Therefore, if the access is concentrated on the logical drive (P) 310, the apparent read speed of the entire storage device 300 will increase. The file access monitoring module 117b interferes only when opening a file. Thus, it does not influence the input/output performance.

Therefore, it is necessary to determine whether or not the logical drive (P) 310 and the logical drive (Q) 320 should hold identical files in an overlapped manner based on the degree of importance of files stored in the disk array (RAID) of the storage device 300 and the required performance.

The system configuration interface 111 presents to a user the file access frequency table 115 collected by the file access monitoring module 117b, receives an entry from a user, and presents a user interface for setting various parameters. The parameters set by the user are stored in the system configuration information 113. The system configuration information 113 holds the five following parameters.

### (System Configuration Information 113: Parameter 1)

The system configuration information 113 holds a threshold of the access frequency that is used in determining a target file to be relocated. Examples of the threshold include: (a) a file that has been accessed five times in ten minutes should be relocated to an SSD, and (b) a file that has been accessed 20 times in one hour should be relocated to an SSD. The system configuration information 113 holds an access count per unit time as the parameter. If the threshold is set to a small value, most of the files that have been accessed are relocated to the logical drive (P) 310. If the threshold is set to a large value, only files that have been accessed frequently are relocated to the logical drive (P) 310.

### (System Configuration Information 113: Parameter 2)

The system configuration information 113 holds a parameter of the timing for booting the file-relocation execution module 117c. Examples of the boot timing include: (a) execute immediately, (b) execute at 0 o'clock midnight, (c) execute when there has been no data access for a given period of time, and (d) execute every weekend. The boot timing is desirably set to hours and the like that will not influence the ordinary data input/output performance.

### (System Configuration Information 113: Parameter 3)

The system configuration information 113 holds the value of a prescribed time for holding the file access frequency table 115 in memory. This parameter is used in step S705.

### (System Configuration Information 113: Parameter 4)

The system configuration information 113 holds the value of the maximum number of records in the file access frequency table 115 to be held in the memory. This parameter is used in step S704.

### (System Configuration Information 113: Parameter 5)

The system configuration information 113 holds a flag that indicates whether or not the logical drive (P) 310 and the logical drive (Q) 320 should hold identical files in an overlapped manner.

### (System Configuration Information 113: Supplement to the Parameters)

The prescribed time for holding the file access frequency table 115 in memory and the maximum number of records are desirably determined appropriately based on the memory size of the computer 100.

The system configuration information 113 is independently accessed from the system configuration interface 111, the file-relocation instruction OS service 112, and the file access monitoring module 117b. Thus, exclusive control should be performed.

The system configuration interface 111 may also be configured to present an increase/decrease in the performance of before and after a user sets each of the aforementioned parameters. As a method for determining a change in the performance when a parameter for relocating a given file A is set, the following calculation method is considered.

First, an access count of the file A per given period of time is determined from an access count of the file A in the file access frequency table 115. The thus determined access count per given period of time is multiplied by the difference in throughput between the logical drive (P) 310 and the logical drive (Q) 320, so that the amount of increase in the throughput after the file is relocated can be determined.

Embodiment 2 has described a specific example of the system configuration interface 111.

### Embodiment 3

Although each of Embodiments 1 and 2 has described an example in which the system configuration interface 111, the file-relocation instruction OS service 112, the filter driver 117, and the RAID device driver 118 are implemented as the “disk array configuration program,” similar functions can be implemented using hardware such as a circuit device.

What is claimed is:

1. A disk array configuration program for causing a computer to execute a process of configuring a disk array in a storage device that includes flash memory and a hard disk, the program comprising:
causing the computer to perform a disk array configuration step of configuring the storage device as a disk array;
causing the computer to perform a sorting step of sorting access to a file in the storage device into access to the flash memory or the hard disk; and
causing the computer to execute a relocation step of relocating a file from the hard disk to the flash memory,
wherein the relocation step comprises:
causing the computer to execute a step of comparing a file size of the file and a block size of the flash memory, and
causing the computer to execute a step of, if the file size is smaller than the block size, storing the file in cache memory without immediately writing the file to the flash memory.

2. The disk array configuration program according to claim 1, wherein
in the disk array configuration step, the computer is caused to configure a single common virtual disk drive that combines the flash memory and the hard disk, and
in the sorting step, the computer is caused to sort access to the common disk drive into access to the flash memory or the hard disk.

3. The disk array configuration program according to claim 1, wherein in the sorting step, the computer is caused to cause the flash memory and the hard disk to hold identical files in an overlapped manner or hold files exclusively.

4. The disk array configuration program according to claim 1, wherein when a directory on the storage device is operated in the sorting step, the computer is caused to create the same directory structure for the flash memory and the hard disk regardless of whether or not to cause the flash memory and the hard disk to hold identical files in an overlapped manner.

5. The disk array configuration program according to claim 1, further comprising causing the computer to execute a monitoring step of monitoring access to files stored in the storage device to acquire access frequency of each file, wherein in the relocation step, the computer is caused to relocate a file whose access frequency is greater than or equal to a predetermined threshold to the flash memory.

6. The disk array configuration program according to claim 1, wherein in the relocation step, the computer is caused to execute a step of immediately writing a file whose file size is greater than or equal to the block size to the flash memory.

7. The disk array configuration program according to claim 5, further comprising:
causing the computer to execute a step of receiving the predetermined threshold specified and reflecting the specified value;
causing the computer to execute a step of receiving a specified condition for executing the relocation step and reflecting the specified condition as an execution timing of the relocation step;
causing the computer to execute a step of receiving a specified time for holding the access frequency in memory and reflecting the specified time;
causing the computer to execute a step of receiving a specified amount of the access frequency to be held in the memory and reflecting the specified amount; and
causing the computer to execute a step of receiving an instruction of whether or not to cause the flash memory and the hard disk to hold identical files in an overlapped manner, and reflecting the specified instruction as an execution condition of the sorting step.

8. The disk array configuration program according to claim 5, further comprising causing the computer to execute the monitoring step, the sorting step, and the relocation step as functions of a filter driver that is configured to trap access to the storage device.

9. A computer for configuring a disk array in a storage device that includes flash memory and a hard disk, comprising:
a disk array configuration unit configured to configure the storage device as a disk array;
a sorting unit configured to sort access to the storage device into access to the flash memory or the hard disk; and
a relocation unit configured to relocate a file from the hard disk to the flash memory; wherein
the relocation unit compares a file size of the file with a block size of the flash memory, and
the relocation unit, if the file size is smaller than the block size, stores the file in cache memory without immediately writing the file to the flash memory.

10. The computer according to claim 9, wherein
the disk array configuration unit configures a single common virtual disk drive that combines the flash memory and the hard disk, and
the sorting unit sorts access to the common disk drive into access to the flash memory or the hard disk.

11. The computer according to claim 9, wherein the sorting unit causes the flash memory and the hard disk to hold identical files in an overlapped manner or hold files exclusively.

12. The computer according to claim 9, wherein the sorting unit, when operating a directory on the storage device, creates the same directory structure for the flash memory and the hard disk regardless of whether or not to cause the flash memory and the hard disk to hold identical files in an overlapped manner.

13. The computer according to claim 9, further comprising a monitoring unit configured to monitor access to files stored in the storage device and acquire access frequency of each file, wherein the relocation unit relocates a file whose access frequency is greater than or equal to a predetermined threshold to the flash memory.

14. The computer according to claim 9, wherein the relocation unit, if the file size is greater than or equal to the block size, immediately writes the file into the flash memory.

15. A computer system comprising:
a storage device including flash memory and a hard disk;
a RAID controller configured to configure a disk array in the storage device; and
a computer configured to write data to the storage device or read data from the storage device, wherein
the computer includes:
a disk array configuration unit configured to configure the storage device as a disk array,
a sorting unit configured to sort access to files in the storage device into access to the flash memory or the hard disk, and
a relocation unit configured to relocate a file from the hard disk to the flash memory,
the relocation unit compares a file size of the file with a block size of the flash memory, and
the relocation unit, if the file size is smaller than the block size, stores the file in cache memory without immediately writing the file to the flash memory.

16. The computer system according to claim 15, wherein
the disk array configuration unit configures a single common virtual disk drive that combines the flash memory and the hard disk, and
the sorting unit sorts access to the common disk drive into access to the flash memory or the hard disk.

17. The computer system according to claim 15, wherein the sorting unit causes the flash memory and the hard disk to hold identical files in an overlapped manner or hold files exclusively.

18. The computer system according to claim 15, wherein the sorting unit, when operating a directory on the storage device, creates the same directory structure for the flash memory and the hard disk regardless of whether or not to cause the flash memory and the hard disk to hold identical files in an overlapped manner.

19. The computer system according to claim 15, further comprising a monitoring unit configured to monitor access to files stored in the storage device and acquire access frequency of each file, wherein the relocation unit relocates a file whose access frequency is greater than or equal to a predetermined threshold to the flash memory.

20. The computer system according to claim 15, wherein the relocation unit, if the file size is greater than or equal to the block size, stores the file in cache memory without immediately writing the file to the flash memory.
